(19) United States
(12) Patent Application Publication
(10) Pub. No.: US 2009/0038899 A1
(43) Pub. Date: Feb. 12, 2009

(54) AUXILIARY HANDLE DEVICE

(76) Inventors: Roswitha Eicher, Filderstadt (DE); Stefan Heess, Leinfelden-Echterdingen (DE); Joerg Maute, Sindelfingen (DE); Florian Esenwein, Uhingen-Holzhausen (DE); Bernhard Eicher, Filderstadt (DE); Marcus Schuller, Dettenhausen (DE)

Correspondence Address: Striker, Striker & Stenby, 103 East Neck Road, Huntington, NY, 11743, US

(21) Appl. No.: 12/132,317

(22) Filed: Jun. 3, 2008

(30) Foreign Application Priority Data
Aug. 6, 2007 (DE) 102007037048.4

(51) Int. Cl. F16F 7/10

(52) U.S. Cl. 188/378

(57) ABSTRACT

An auxiliary handle device, in particular for a hand-held power tool, has an auxiliary handle and a damping unit with at least one absorber mass element. The absorber mass element is designed in the shape of a sleeve along a main extension direction of the auxiliary handle device.

### CROSS-REFERENCE TO A RELATED APPLICATION

The invention described and claimed hereinbelow is also described in German Patent Application 10 2007 037 048.4 filed on Aug. 6, 2007. This German Patent Application, whose subject matter is incorporated here by reference, provides the basis for a claim of priority of invention under 35 U.S.C. 119(a)-(d).

### BACKGROUND OF THE INVENTION

The present invention is directed to an auxiliary handle device.

An auxiliary handle device for a hand-held power tool is already known, the auxiliary handle device including an auxiliary handle and a damping unit. The damping unit includes an absorber mass element that serves to dampen vibrations.

### SUMMARY OF THE INVENTION

The present invention is directed to an auxiliary handle device, in particular for a hand-held power tool, with an auxiliary handle and a damping unit that includes at least one absorber mass element.

It is provided that the absorber mass element is designed in the shape of a sleeve along a main extension direction of the auxiliary handle.

In this context, an “auxiliary handle” is understood to be a region and/or a component and/or an element provided for placement—and enclosing, in particular—by one or two hands of an operator for guiding a hand-held power tool using an auxiliary handle device, and which is capable of being attached to the hand-held power tool in an auxiliary manner, adjacent to a further handle, in particular the main handle, the auxiliary handle device being located on the side of the hand-held power tool, and/or being capable of being removed from the hand-held power tool by an operator without the use of tools, and/or being located in a front region of the hand-held power tool close to the tool, and/or the auxiliary handle is designed in the shape of a rod.

An “absorber mass element” refers, in particular, to an element that is excited—at least within one intended frequency range of an initial oscillation and/or excitation oscillation—to generate a counter-oscillation that counteracts the initial or excitation oscillation, and therefore contributes to a reduction of vibrations. “Along a main extension direction of the auxiliary handle” is understood to mean an orientation and/or placement of the absorber mass element in particular, the length of the absorber mass element being oriented preferably parallel to the main extension direction and/or to a length of the auxiliary handle. The inventive design provides an advantageous damping of the auxiliary handle—of the gripping region in particular—and, therefore, a high level of operating comfort for an operator. In particular, vibrations may be advantageously damped along a preferred direction, e.g., along the main extension direction. The inventive auxiliary handle device is basically usable in conjunction with all hand-held power tools that appear reasonable to one skilled in the technical art, thereby making it easier, in particular, for an operator to guide hand-held power tools using the auxiliary handle. Due to its damping property, the auxiliary handle device is particularly advantageous when used with an angle grinder.

It is also provided that the auxiliary handle includes a grip sleeve that serves as a receiving area for receiving the absorber mass element, thereby providing a receiving function with a simple design and making it possible to locate the damping unit and/or the absorber mass element inside the auxiliary handle device in a particularly space-saving manner.

When the grip sleeve is supported in a radial and/or axial direction via the absorber mass element, an undesired and, in particular, direct transfer of vibrations from the hand-held power tool to the grip sleeve may be prevented. The grip sleeve is preferably located around the absorber mass element, thereby ensuring advantageous support of the grip sleeve in the radial and/or axial direction via the absorber mass element.

In a further embodiment of the present invention, it is provided that the damping unit includes at least one damping element that supports the absorber mass element in at least one direction, thereby making it possible to attain an advantageous, vibration-damping support of the absorber mass element along an axial and/or radial direction of the auxiliary handle. The axial direction is preferably oriented parallel with the main extension direction of the auxiliary handle, and the radial direction is oriented radially outwardly from an auxiliary handle axis that extends parallel with the main extension direction.

An advantageous support of the absorber mass element that enables a counter-oscillation to be generated may be attained when the damping element is a rolling element. The rolling element is preferably designed as a bearing, a ring, and/or further rolling elements that appear reasonable to one skilled in the technical art.

An advantageous support of the absorber mass element may also be attained when the damping element is made of an elastomer and/or a ring and/or a damping fluid. The elastomer preferably encloses a rubber-like, elastic material. The damping fluid is advantageously a pure fluid, a suspension, and/or further damping fluids that appear reasonable to one skilled in the technical art.

In an advantageous refinement of the present invention, it is provided that the damping unit includes at least one adjusting element that is provided for adjusting at least one damping parameter of the damping element. With this, the damping parameter may be advantageously adapted to an oscillatory behavior of the hand-held power tool. It is advantageously provided that the damping parameter is adjusted by an operator of the auxiliary handle device.

It is also provided that the damping unit includes at least a second sleeve-shaped absorber mass element, thereby ensuring that particularly effective damping of vibrations may be attained via the damping unit when the hand-held power tool and/or the auxiliary handle device are operated.

Particularly advantageous damping inside the auxiliary handle device that is adapted to a different oscillatory behavior, e.g., different oscillation frequencies in particular, may be attained when the different absorber mass elements have different damping properties. The absorber mass elements differ preferably in terms of the material, mass, volume or shape, and/or in terms of other properties that appear reasonable to one skilled in the art. The different properties of the individual absorber mass elements result in different damping properties.

A particularly compact damping unit with a particularly space-saving arrangement of the individual absorber mass elements may be advantageously attained when at least one of the sleeve-shaped absorber mass elements is located at least partially inside a further sleeve-shaped absorber mass element. The sleeve-shaped absorber mass element is preferably supported inside the further sleeve-shaped absorber mass element using a damping element, e.g., using an elastomer ring and/or further damping elements that appear reasonable to one skilled in the art.

It is also provided that at least one absorber mass element includes a segment-like projection in a radial direction, thereby making it possible to integrate an advantageous unbalanced mass for generating a counter-oscillation inside the damping unit. In this context, a “segment-like projection” refers, in particular, to a projection that preferably extends around a circular segment by a maximum of 180°, particularly advantageously by a maximum of 90°, and particularly preferably, it extends around a circular segment by a maximum of 45°, and/or is designed in the shape of a peg in particular.

### BRIEF DESCRIPTION OF THE DRAWINGS

FIG. 1 shows a hand-held power tool with an inventive auxiliary handle device, in a schematic depiction,

FIG. 2 shows the auxiliary handle device with an inventive damping unit, in a sectional view,

FIG. 3 shows the auxiliary handle device with an alternative damping unit that includes several absorber mass elements, in a sectional view,

FIG. 4 shows the auxiliary handle device with an alternative damping unit that includes a grip sleeve supported by absorber mass elements, in a sectional view, and

FIG. 5 shows the auxiliary handle device with an alternative damping unit that includes a segment-like unbalanced mass, in a sectional view.

### DESCRIPTION OF THE PREFERRED EMBODIMENTS

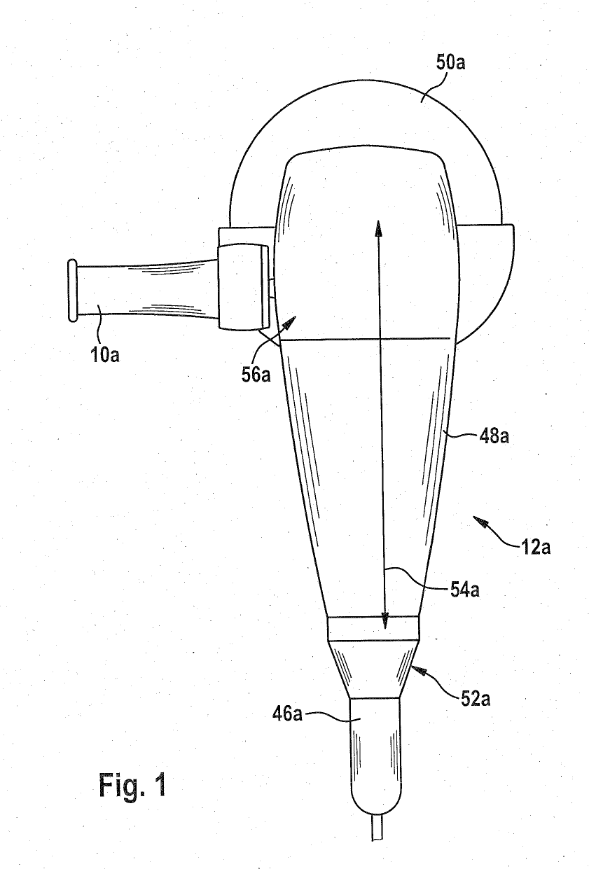

A hand-held power tool 12a designed as an angle grinder is shown in FIG. 1, in a perspective view from above. Angle grinder includes a housing 48a and a main handle 46a integrated in housing 48a. Main handle 46a extends along a side 52a facing away from a tool 50a that is a cutting disk, in a longitudinal direction 54a of the angle grinder. An auxiliary handle device 10a is located in a front region 56a of the angle grinder that is close to the tool, and extends transversely to longitudinal direction 54a of the angle grinder.

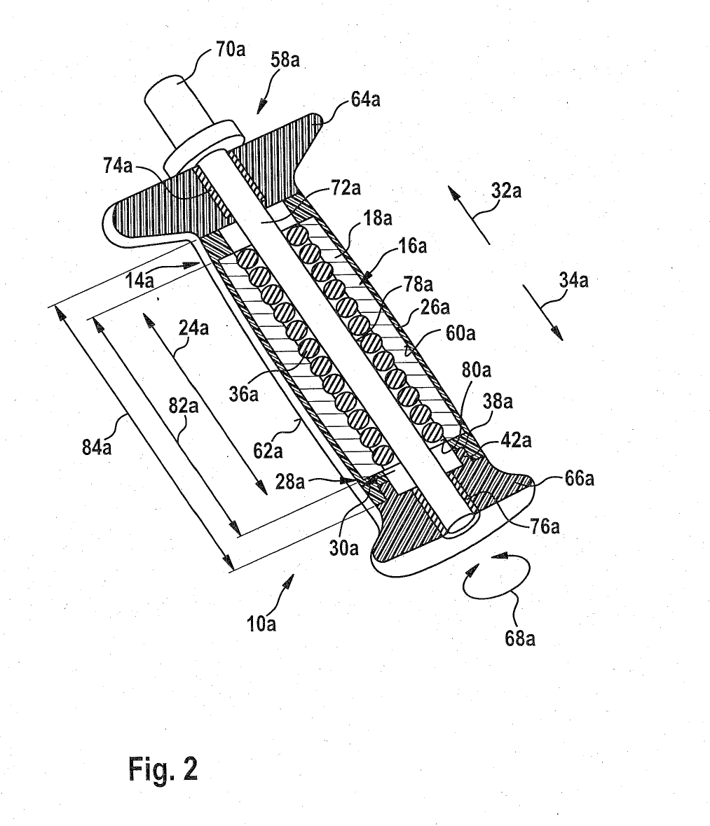

FIG. 2 shows auxiliary handle device 10a with an auxiliary handle 14a, a fastening unit 58a, and a damping unit 16a. Additional handle 14a includes a grip sleeve 26a, which extends along a main extension direction 24a of auxiliary handle device 10a. Grip sleeve 26a forms—together with a radially inwardly facing surface 60a—a receiving area 28a, which is provided to receive damping unit 16a. Receiving area 28a is designed cylindrical in shape along main extension direction 24a. Auxiliary handle 14a and/or grip sleeve 26a has a surface 62a that is curved radially outwardly along main extension direction 24a of auxiliary handle 14a, thereby providing a particularly good grip for an operator of auxiliary handle device 10a.

A ridge-type raised area is provided along main extension direction 24a in end regions 64a, 66a of auxiliary handle device 14a, which limits a gripping region of grip sleeve 26a for an operator of auxiliary handle device 10a along main extension direction 24a. The two ridge-type raised areas are located on auxiliary handle 14a in the manner of rings, in a circumferential direction 68a, which extends perpendicularly to main extension direction 24a. The two ridge-type raised areas extend radially outwardly from auxiliary handle 14a. During operation of auxiliary handle device 10a, ridge-type raised areas prevent the operator's hand from slipping when the operator guides hand-held power tool 12a using auxiliary handle device 10a and/or while force is being transmitted by the operator via auxiliary handle device 10a to hand-held power tool 12a.

Fastening unit 58a, which is designed to be screwed together with hand-held power tool 12a, includes a bolt-shaped fastening element 70a. A support element 72a abuts fastening unit 58a and extends in main extension direction 24a through end region 64a facing fastening unit 58a and through receiving area 28a, and is fastened to end region 66a facing away from fastening unit 58a. Support element 72a is designed as a single piece with fastening unit 58a. Damping elements 74a, 76a made of an elastomer are located in a radial direction 30a between support element 72a and end regions 64a, 66a. Damping elements 74a, 76a prevent a direct transfer of oscillations from support element 72a to end regions 64a, 66a and, therefore, to grip sleeve 26a.

Damping unit 16a includes a sleeve-shaped absorber mass element 18a, which is located inside receiving area 28a along main extension direction 24a of auxiliary handle device 14a. Absorber mass element 18a is located around support element 72a, in radial direction 30a. To provide an additional vibration damping effect, further damping elements 36a are located along a path of vibration transmission from support element 72a in radial direction 30a outwardly to absorber mass element 18a. Damping elements 36a are formed by rolling elements designed as elastomer balls. It is also basically feasible for damping elements 36a to be designed as elastomer rings and/or as further rolling elements that appear reasonable to one skilled in the technical art.

The elastomer balls bear against a radially outwardly oriented surface 78a of support element 72a and against a radially inwardly oriented surface 80a of absorber mass element 18a. Absorber mass element 18a is thereby supported relative to support element 72a via the elastomer balls. Damping elements 36a, i.e., the elastomer balls, dampen vibrations and/or absorb oscillation energy. The oscillation energy is at least partially absorbed and converted into internal friction energy of the elastomer balls and/or into external friction energy when the elastomer balls move relative to support element 72a. Absorber mass element 18a abuts the elastomer balls outwardly in radial direction 30a. Absorber mass element 18a is provided to generate a counter-oscillation and/or vibration that opposes an initial oscillation of hand-held power tool 12a. Absorber mass element 18a is designed to absorb vibrations preferably in an axial direction 32a, 34a, which is oriented parallel with main extension direction 24a of auxiliary handle 14a. Absorber mass element 18a has a length 82a that is shorter than a length 84a of receiving area 28a, thereby enabling counter-oscillations to be generated in axial direction 32a, 34a during operation of hand-held power tool 12a.

Grip sleeve 26a abuts sleeve-shaped absorber mass element 18a outwardly in radial direction 30a. Grip sleeve 26a is supported by absorber mass element 18a in radial direction 30a and is formed by an elastic coating around absorber mass element 18a applied via injection molding. The elastic coating is also located inside receiving area 28a between absorber mass element 18a and end regions 64a, 66a. The elastic coating serves as damping element 38a and essentially prevents a direct transmission of vibrations from support element 72a and/or end regions 64a, 66a to grip sleeve 26a during operation of hand-held power tool 12a and/or auxiliary handle device 10a. The elastic coating of receiving area 28a also forms a closed space, which may be filled with a damping fluid to further enhance a vibration-damping property of damping unit 16a. To adjust a damping parameter of damping element 38a and/or to adjust a maximum counter-oscillation of absorber mass element 18a, end region 66a facing away from fastening unit 58a is provided with a threaded adjusting element 42a, which is screwed together with damping element 38a. Length 84a of receiving area 28a may be adjusted using adjusting element 42a. It is also feasible, however, for grip sleeve 26a—together with absorber mass element 18a—to be located at a distance from end regions 64a, 66a, and for grip sleeve 26a to therefore be located such that it is decoupled from vibrations from end regions 64a, 66a.

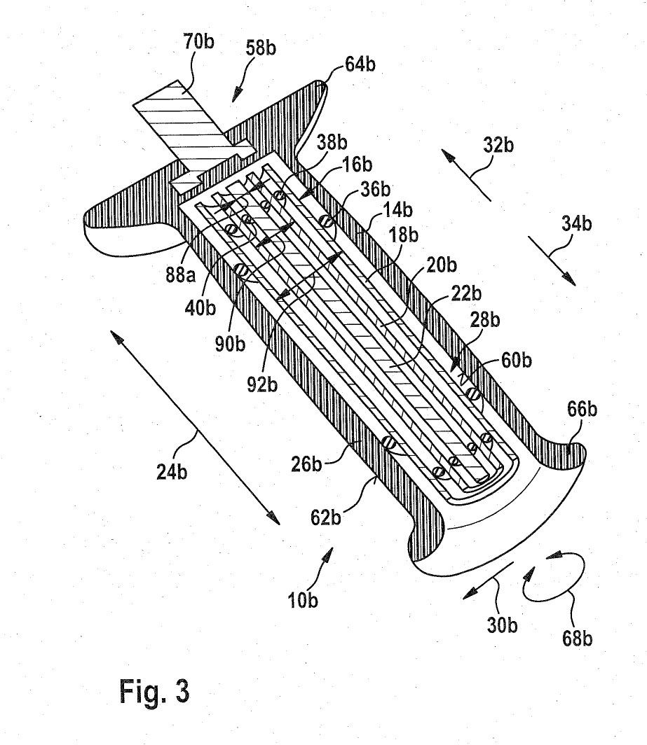

Alternative exemplary embodiments are shown in FIGS. 3 through 5. Components, features, and functions that are essentially the same are labeled with the same reference numerals. To distinguish the exemplary embodiments from each other, the reference numerals of the exemplary embodiments are appended with the letters a through d. The description below is essentially limited to the differences from the exemplary embodiment in FIGS. 1 and 2. With regard for the components, features, and functions that remain the same, reference is made to the description of the exemplary embodiment shown in FIGS. 1 and 2.

FIG. 3 shows an alternative auxiliary handle device 10b with a damping unit 16b that includes three sleeve-shaped absorber mass elements 18b, 20b, 22b. The three absorber mass elements 18b, 20b, 22b are located inside a receiving area 28b of an auxiliary handle 14b of auxiliary handle device 10b. Receiving area 28b is designed open in axial direction 34b at an end region 66b facing away from a fastening unit 58b. Fastening unit 58b includes a fastening element 70b, which is connected with an end region 64b facing fastening unit 58b via a form-fit, non-positive, and/or bonded connection.

The three absorber mass elements 18b, 20b, 22b differ in terms of their masses and diameters 88b, 90b, 92b. The three absorber mass elements 18b, 20b, 22b may also differ in terms of a material and/or other properties that appear suitable to one skilled in the technical art. Absorber mass element 22b with the smallest diameter 88b is enclosed outwardly in a radial direction 30b by absorber mass element 20b with mid-range diameter 90b. In turn, absorber mass element 20b is enclosed by absorber mass element 18b with greatest diameter 92b. Damping elements 38b, 40b designed as elastomer rings are located between absorber mass elements 18b, 20b, 22b in radial direction 30b to support individual absorber mass elements 18b, 20b, 22b relative to each other. In order to provide equal support to absorber mass elements 18b, 20b, 22b along a main extension direction 24b of auxiliary handle 14b, annular damping elements 36b, 38b, 40b are located between absorber mass elements 18b, 20b, 22b, and between absorber mass element 18b and grip sleeve 26b in regions of receiving area 28b facing end regions 64b, 66b.

In order to attach absorber mass elements 18b, 20b, 22b inside receiving area 28b, damping elements 36b, 38b, 40b are integrally extruded with grip sleeve 26b and absorber mass elements 18b, 20b, 22b. It is also basically feasible for damping elements 36b, 38b, 40b to be clamped between absorber mass elements 18b, 20b, 22b and/or between absorber mass element 18b and grip sleeve 26b, thereby securing absorber mass elements 18b, 20b, 22b in axial direction 32b, 34b inside receiving area 28b using pressure-generated tension. It is also feasible for receiving area 28b to be closed to the outside at end region 66b facing away from fastening unit 58b, and for absorber mass elements 18b, 20b, 22b to also be supported in a damping fluid.

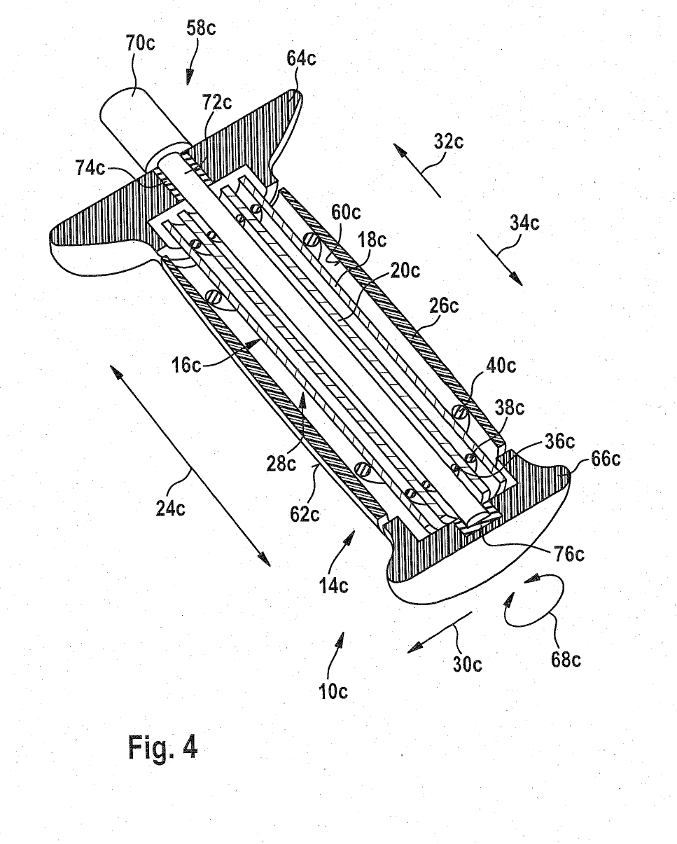

FIG. 4 shows an alternative auxiliary handle device 10c with a damping unit 16c that includes two sleeve-shaped absorber mass elements 18c, 20c. In contrast to the exemplary embodiment shown in FIG. 3, a fastening unit 58c is designed as a single piece with a support element 72c that extends through a receiving area 28c along a main extension direction 24c of an auxiliary handle 14c. The two absorber mass elements 18c, 20c are located around support element 72c, outwardly in a radial direction 30c. Damping elements 36c, 38c designed as elastomer rings are located between absorber mass elements 18c, 20c and/or between absorber mass element 20c and support element 72c. Damping elements 36c, 38c are applied to absorber mass elements 18c, 20c and/or support element 72c via injection molding. It is also basically feasible, however, for damping elements 36c, 38c to be clamped between absorber mass elements 18c, 20c and/or between absorber mass element 20c and support element 72c. A grip sleeve 26c of auxiliary handle 14c is supported relative to absorber mass element 18c in radial direction 30c via integrally extruded damping elements 40c designed as elastomer rings. Grip sleeve 26c is separated from end regions 64c, 66c of auxiliary handle 14c along main extension direction 24c, thereby ensuring that grip sleeve 26c is vibration-decoupled or vibration-damped relative to end regions 64c, 66c in axial direction 32c, 34c.

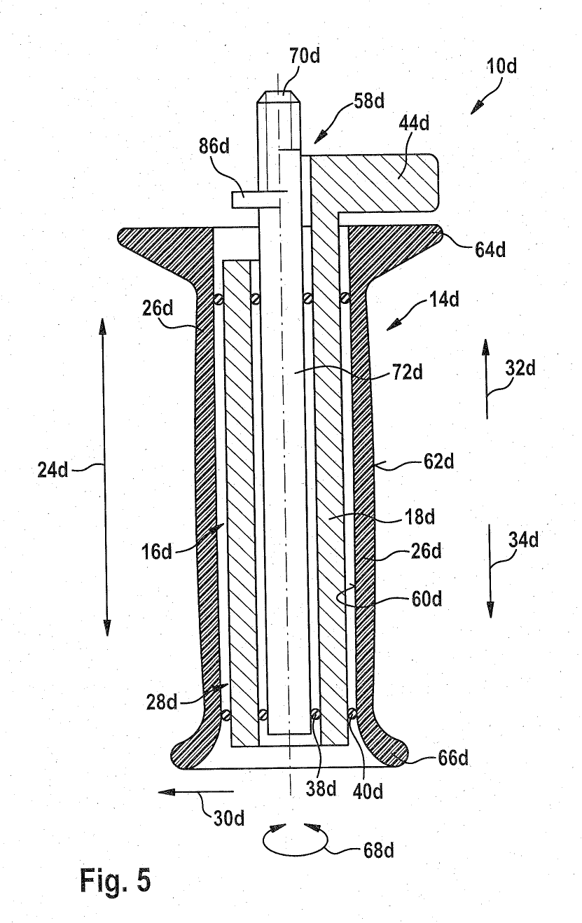

FIG. 5 shows an alternative auxiliary handle device 10d with a damping unit 16d that includes a sleeve-shaped absorber mass element 18d. As explained with reference to the designs shown in FIGS. 3 and 4, a grip sleeve 26d is supported in a radial direction 30d relative to absorber mass element 18d via damping elements 40d designed as elastomer rings. Absorber mass element 18d is supported via damping elements 38d designed as elastomer rings relative to a support element 72d, which is designed as a single piece with a fastening unit 58d. A receiving area 28d of an auxiliary handle 14d is designed open toward an end region 64d facing fastening unit 58d and toward an end region 66d facing away from fastening unit 58d, in the region of fastening unit 58d, absorber mass element 18d extends in axial direction 32d beyond auxiliary handle 14d.

In this region, absorber mass element 18d includes a peg-shaped, segment-like projection 44d that extends outwardly in radial direction 30d. Segment-like projection 44d extends along a maximum angular range of 45° in a circumferential direction 68d, and is provided to increase inertia and/or to produce an imbalance in order to absorb vibrations by generating a counter-oscillation. A fastening element 70d of fastening unit 58d includes a peg-shaped element 86d along axial direction 32d, 34d in the region of segment-like projection 44d of absorber mass element 18d. Peg-shaped element 86d extends radially outwardly from fastening element 70d and is located on a side of fastening element 70d opposite to segment-like projection 44d.

It will be understood that each of the elements described above, or two or more together, may also find a useful application in other types of constructions differing from the types described above.

While the invention has been illustrated and described as embodied in a auxiliary handle device, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. An auxiliary handle device, comprising an auxiliary handle; and a damping unit with at least one absorber mass element, said absorber mass element being configured in a shape of a sleeve along a main extension direction of the auxiliary handle device.

2. An auxiliary handle device as defined in claim 1, wherein said auxiliary handle includes a grip sleeve that serves as a receiving area for receiving said absorber mass element.

3. An auxiliary handle device as defined in claim 2, wherein said grip sleeve is supported in a direction selected from the group consisting of a radial direction, an axial direction, and both, via said absorber mass element.

4. An auxiliary handle device as defined in claim 1, wherein said damping unit includes at least one damping element configured to support said absorber mass element in at least one direction.

5. An auxiliary handle device as defined in claim 4, wherein said damping element is configured a rolling element.

6. An auxiliary handle device as defined in claim 4, wherein said damping element is composed of an elastomer.

7. An auxiliary handle device as defined in claim 4, wherein said damping element is configured as a ring.

8. An auxiliary handle device as defined in claim 4, wherein said damping unit includes at least one adjusting element for adjusting at least one damping parameter of said damping element.

9. An auxiliary handle device as defined in claim 1, wherein said damping unit includes at least a second sleeve-shaped absorber mass element.

10. An auxiliary handle device as defined in claim 9, wherein said absorber mass elements have different damping properties.

11. An auxiliary handle device as defined in claim 9, wherein at least one of said sleeve-shaped absorber mass elements is located at least partially inside a further sleeve-shaped absorber mass element.

12. An auxiliary handle device as defined in claim 11;
further comprising a damping element, via which such sleeve-shaped absorber mass element is supported inside the further sleeve-shaped absorber mass element.

13. An auxiliary handle device as defined in claim 1, wherein at least one of said absorber mass elements includes a segment-type extension in a radial direction.

14. A hand-held power tool, comprising a main handle device; and an auxiliary handle device, said auxiliary handle device including an auxiliary handle; and a damping unit with at least one absorber mass element, said absorber mass element being configured in a shape of a sleeve along a main extension direction of the auxiliary handle device.

15. A hand-held power tool as defined in claim 14, wherein the hand-held power tool is configured as an angle grinder.
